(19) United States
(12) Patent Application Publication
(10) Pub. No.: US 2026/0251171 A1
(43) Pub. Date: Aug. 27, 2026

(54) Compression Limiting Box Nut

(71) Applicant: Illinois Tool Works Inc., Glenview, IL (US)

(72) Inventor: Kathryn Grace Bailey, Farmington, MI (US)

(21) Appl. No.: 19/541,109

(22) Filed: Feb. 16, 2026

Related U.S. Application Data
(60) Provisional application No. 63/762,848, filed on Feb. 25, 2025.
(60) Provisional application No. 63/767,031, filed on Mar. 5, 2025.

(51) Int. Cl. F16B 37/04; F16B 5/06; F16B 37/06

(52) U.S. Cl. CPC F16B 37/041; F16B 5/065; F16B 37/044; F16B 37/065

(57) ABSTRACT

A nut clip for coupling a first component to a second component includes a body portion formed from sheet metal, and a fastener plate supporting an internally threaded collar defining an internally threaded bore along an axis. The nut clip is configured to establish a predetermined stand-off height between the first and second components when a threaded fastener is tightened within the internally threaded bore, thereby maintaining a spacing between the first and second components. In an example, the nut clip is configured as a box nut having retention legs configured to engage an opening in the first component.

### RELATED APPLICATIONS

The present application claims priority to U.S. Provisional Patent Application Nos. 63/762,848, filed Feb. 25, 2025, and 63/767,031, filed Mar. 5, 2025, each of which are hereby incorporated by reference.

### BACKGROUND

Automotive components require fastening solutions that are straightforward to manufacture and assemble, while delivering high reliability and operational efficiency. In vehicle body and chassis applications, clips are frequently used to secure dissimilar materials, such as aluminum panels to steel structures or coated components to bare substrates. When such materials are placed in direct contact in the presence of moisture or road contaminants, galvanic corrosion may occur, leading to premature degradation, reduced structural integrity, and increased warranty costs. Accordingly, there is a need for fastening solutions that not only secure components but also provide electrical and/or physical isolation between adjacent parts to mitigate the effects of galvanic corrosion.

Clips are widely used across numerous industries to secure, fasten, or retain components. Conventional clip designs typically rely on elastic deformation to generate clamping force. However, excessive compression during installation or in-service loading may result in material fatigue, permanent deformation, or failure of the clip and/or the retained components. In automotive panel assemblies and other structural interfaces, over-compression can crush coatings, deform lightweight materials, or compromise sealing features. In sensitive applications—such as electronics, medical devices, precision assemblies, and vehicle body panels—it is particularly important to control the maximum compressive force applied in order to prevent damage and ensure proper function.

Accordingly, notwithstanding existing developments, there remains a need for an improved clip that provides secure retention while isolating adjacent components to reduce or eliminate galvanic corrosion, and, in some cases, incorporates features that limit maximum compression to prevent crushing or deformation of one or more retained components. Such a clip would enhance durability, protect surface treatments and lightweight materials, safeguard delicate components, and promote consistent performance over repeated installation and removal cycles.

### SUMMARY

The present disclosure relates generally to a nut clip forming a connection between two components, such as vehicular components, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1a illustrates a topside isometric assembly view of a fastening system with a fastener assembly having a nut clip in accordance with an aspect of this disclosure.

FIG. 1b illustrates a topside isometric assembled view of the fastening system.

FIG. 1c illustrates a cross-sectional side elevation view of the fastening system taken along cutline A-A (FIG. 1b).

FIG. 2a illustrates a topside isometric view of the nut clip for FIGS. 1a through 1c.

FIG. 2b illustrates an underside isometric view of the nut clip.

FIG. 2c illustrates a top plan view of the nut clip.

FIG. 2d illustrates a bottom plan view of the nut clip.

FIG. 2e illustrates an elevation view of a first side of the nut clip.

FIG. 2f illustrates an elevation view of a second side of the nut clip.

FIG. 2g illustrates an elevation view of a third side of the nut clip.

FIG. 2h illustrates an elevation view of a fourth side of the nut clip.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered. It will be understood that directional references (e.g., upper, lower, upwardly, downwardly) are used for convenience with respect to the orientation shown in the figures and are not intended to limit the scope of the disclosure.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. Terms such as “can,” “may,” and “in certain embodiments” are used to reflect that variations are contemplated. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Disclosed is a nut clip to form a connection between two components, such as vehicular components.

In one example, a nut clip comprises: a body portion configured to engage an opening of a first component; an internally-threaded collar supported by the body portion and defining an internally-threaded bore configured to receive a threaded fastener along an axis; and a compression limiter extending from the body portion along the axis, wherein the compression limiter is configured to engage a second component during tightening of the threaded fastener and define a predetermined maximum compression condition between the first component and the second component.

In some examples, the compression limiter comprises a hollow cylindrical wall defining a fastener opening aligned with the internally-threaded bore.

In some examples, the hollow cylindrical wall is configured to be at least partially received within the opening of the second component.

In some examples, the compression limiter and the internally-threaded collar are generally concentric about the axis.

In some examples, the compression limiter extends in a first axial direction and the internally-threaded collar extends in an opposite axial direction.

In some examples, the compression limiter is integrally formed from material of the body portion.

In some examples, the compression limiter is configured to transfer compressive load between the first component and the second component when the threaded fastener is tightened.

In some examples, the compression limiter defines a predetermined axial height corresponding to a maximum allowable compression between the first component and the second component.

In some examples, the body portion further comprises resilient retention features configured to engage the opening of the first component in a snap-fit or interference-fit manner.

In some examples, the resilient retention features comprise a pair of legs extending from a fastener plate and including at least one attachment feature configured to resist push-through of the nut clip relative to the first component.

In one example, a nut clip comprises: a planar portion; a fastener plate spaced from the planar portion; an internally-threaded collar extending from the fastener plate and configured to receive a threaded fastener; wherein the planar portion and the fastener plate are arranged substantially parallel to one another and are spaced apart by a predetermined distance, and wherein the predetermined distance is configured to provide isolation between a first component and a second component when the nut clip is installed therebetween.

In some examples, the nut clip further comprises at least one spacing feature disposed between the planar portion and the fastener plate and configured to maintain the predetermined distance under compressive load.

In some examples, the at least one spacing feature comprises one or more dimples formed in the fastener plate.

In some examples, the planar portion includes a compression limiter extending away from the fastener plate.

In some examples, the planar portion and the fastener plate are integrally formed from a single piece of sheet metal material.

In some examples, the planar portion is configured to engage a second component, and the fastener plate is configured to engage a first component such that the predetermined distance reduces direct metal-to-metal contact between the first component and the second component.

In some examples, the nut clip further comprises at least one resilient retention feature extending from the fastener plate and configured to engage an opening of the first component.

In some examples, the predetermined distance corresponds to a defined stand-off height that is maintained during tightening of a threaded fastener engaged with the internally-threaded collar.

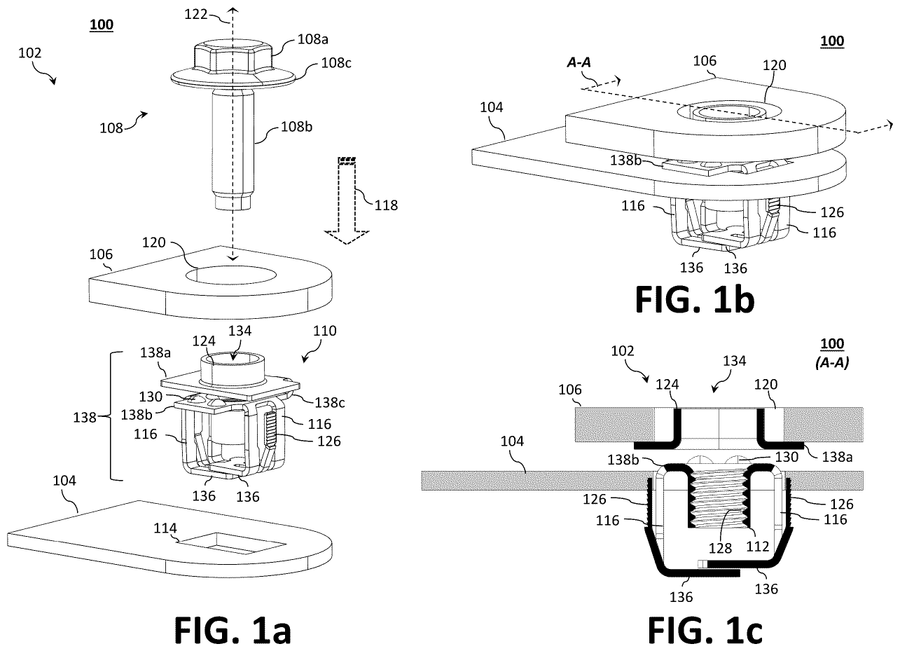

FIG. 1a illustrates a topside isometric assembly view of a fastening system 100 with a fastener assembly 102 having a nut clip 110 in accordance with an aspect of this disclosure. FIG. 1b illustrates a topside isometric assembled view of the fastening system 100, while FIG. 1c illustrates a cross-sectional side elevation view of the fastening system 100 taken along cutline A-A (FIG. 1b).

The fastening system 100 can include a fastener assembly 102 configured to couple a first component 104 to a second component 106. The fastening system 100 may be suitable for automotive applications, although it will be appreciated that the fastening system 100 can be used in other industries and environments where controlled clamping, component isolation, compression limiting, and secure retention are desirable.

In this example, the nut clip 110 is configured as a box nut including a compression limiter 124 integrated into an upper portion of the body portion 138 while retaining box nut functionality on a lower portion. The nut clip 110 is configured for insertion into a generally square or rectangular opening of a first component 104, thereby enabling compatibility with conventional aperture geometries and installation processes. The compression limiter 124 is formed from the planar portion 138a, which is folded back relative to the fastener plate 138b via spring bend 138c to define a predetermined axial stand-off height. The internally threaded collar 112 (e.g., a tapped draw) extends from the fastener plate 138b in an opposite axial direction and defines an internally threaded bore 128 configured to receive a fastener 108 along axis 122.

The folded-back planar portion 138a can provide an enlarged bearing surface configured to engage a second component 106 and distribute compressive load when the fastener 108 is tightened. The configuration may facilitate snap-in retention within the opening of the first component 104 and resist push-through during installation. Unlike certain conventional locating U-nuts that may deflect and pass beyond an opening without positive engagement, the nut clip 110 may be configured to positively locate and clip into the opening via legs 116 and associated retention features 126, thereby providing tactile and/or audible feedback upon proper seating.

By structurally separating the retention function (e.g., via the legs 116 and retention features 126) from the compression-limiting function (via the compression limiter 124), the nut clip 110 enables independent control of installation retention and clamp load management. The compression limiter 124 can define a maximum compression condition between the first component 104 and the second component 106, thereby mitigating over-compression, crushing of coatings, or deformation of adjacent components while enhancing installation reliability and positional accuracy.

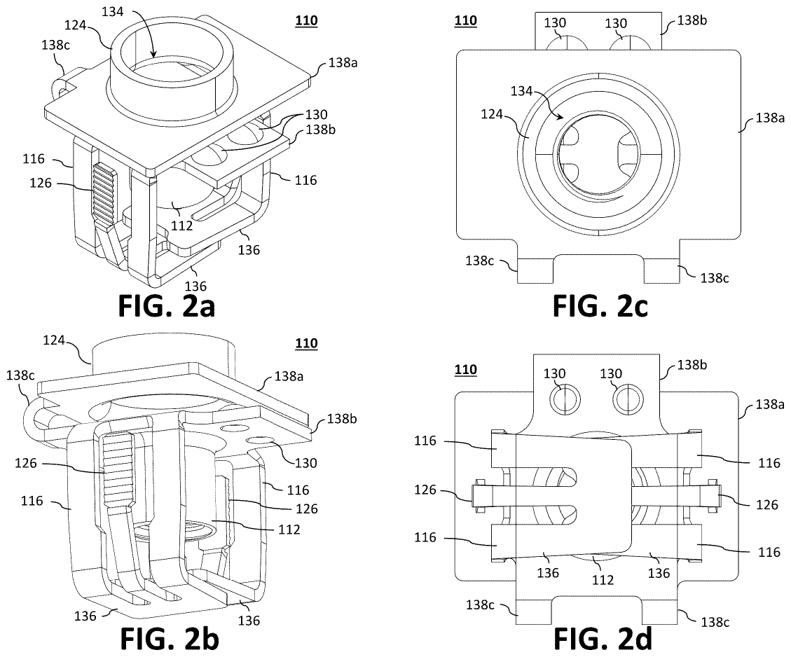

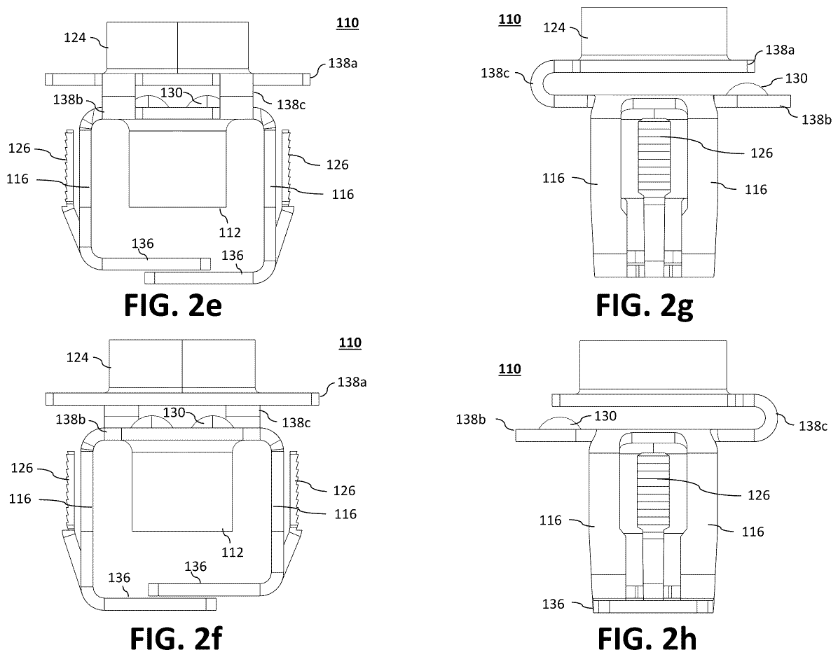

The fastener assembly 102 can include a fastener 108 and a nut clip 110. FIG. 2a illustrates a topside isometric view of the nut clip 110 for FIGS. 1a through 1c, while FIG. 2b illustrates an underside isometric view of the nut clip 110. FIGS. 2c and 2d illustrate, respectively, top and bottom plan views of the nut clip 110. FIGS. 2e through 2h illustrate, respectively, elevation views of a first, second, third, and fourth side of the nut clip 110.

The nut clip 110 may include an internally threaded collar 112 configured to threadedly receive the fastener 108 along an axis of rotation 122, as well as a compression limiter 124 configured to engage the second component 106 and control axial compression between the first component 104 and the second component 106 (by limiting compression of the fastener 108). In certain embodiments, the compression limiter 124 can define a predetermined stand-off distance corresponding to a maximum allowable compression condition when the fastener 108 is tightened. The predetermined stand-off distance can correspond to, for example, the thickness of the second component 106. In some embodiments, the compression limiter 124 can act as a load-transferring stand-off structure positioned between the components to maintain separation under clamp load.

The nut clip 110 can further be configured to provide mechanical retention to the first component 104 prior to full assembly and to provide electrical and/or physical isolation between adjacent components.

The first component 104 and the second component 106 may be fabricated from similar or dissimilar materials. In automotive applications, for example, the first component 104 may comprise a steel structural member and the second component 106 may comprise an aluminum panel, coated substrate, composite structure, or polymeric trim component. When dissimilar metals are placed in contact in the presence of moisture or road contaminants, galvanic corrosion may occur. The nut clip 110 can be configured to maintain a controlled spacing between the first component 104 and the second component 106 when installed, thereby reducing direct metal-to-metal contact and mitigating galvanic corrosion.

To facilitate installation of the fastener assembly 102, the first component 104 can include a first opening 114, and the second component 106 can include a second opening 120. In the illustrated embodiment, the first opening 114 may be generally quadrilateral, such as square or rectangular, and may be dimensioned to receive at least a portion of the nut clip 110 in a snap-fit or interference-fit manner. The second opening 120 may be generally circular and may be dimensioned to receive the shank 108b of the fastener 108 and, in certain embodiments, to receive at least a portion of the compression limiter 124 to provide alignment and radial positioning of the fastener 108 relative to the nut clip 110.

The first opening 114 and the second opening 120 may be formed during manufacture of the respective components (e.g., stamping, punching, molding, casting) or may be formed in a secondary operation (e.g., drilling, laser cutting, machining). Optional chamfers, radiused edges, or lead-in features may be included to facilitate insertion, centering, and alignment of the nut clip 110 and/or fastener 108.

When assembled, the second component 106 can be positioned relative to the first component 104 such that the second opening 120 is aligned with the first opening 114 and the internally threaded collar 112 of the nut clip 110, with the compression limiter 124 positioned between the components and extending into or toward the second opening 120.

The nut clip 110 can include a body portion 138, which in certain embodiments may be formed from a single piece of material, such as sheet metal. The body portion 138 may include opposing one or more planar portions (e.g., planar portion 138a) connected to a fastener plate 138b by one or more integral spring bends 138c, such as U-shaped bends. The spring bends 138c can impart resilient characteristics to the nut clip 110 and may enable the nut clip 110 to elastically deform during insertion into the first opening 114 and return toward a predetermined unstressed configuration to provide retention.

In the illustrated embodiment, the nut clip 110 may be configured as a box nut. A fastener plate 138b can form a lower portion of the nut clip 110 and may support or define the internally threaded collar 112. A pair of legs 116 may extend generally perpendicular from the fastener plate 138b. The distal ends 136 of the legs 116 can be bent inwardly and may be generally parallel to the fastener plate 138b, thereby forming a box-like structure. In certain embodiments, the distal ends 136 may overlap one another. One or more attachment features, such as tabs 126, may be provided on the legs 116 to engage edges of the first opening 114 and provide retention. These retention features can be configured to resist push-through of the nut clip 110 relative to the first component 104 and to provide tactile and/or audible feedback when fully seated.

The nut clip 110 may be configured for insertion into a conventional square or rectangular aperture in the first component 104. Upon insertion, the legs 116 can elastically deflect and then engage the perimeter of the first opening 114. The retention function provided by the legs 116 and tabs 126 may be structurally distinct from the compression-limiting function provided by the compression limiter 124, thereby allowing independent optimization of retention force and compression control.

The fastener plate 138b may comprise or define the internally threaded collar 112. The internally threaded collar 112 can include a cylindrical body defining an internally threaded bore 128. The bore 128 may be configured to threadedly engage the externally threaded shank 108b of the fastener 108. In certain embodiments, the cylindrical body may be formed by extrusion of material from the fastener plate 138b and subsequently tapped or thread-formed to define internal threads. The internally threaded collar 112 can be rotationally fixed relative to the body portion 138 such that rotation of the fastener 108 about axis 122 advances the fastener axially without causing substantial rotation of the nut clip 110 during tightening.

The planar portion 138a can include an integrally formed compression limiter 124. In the illustrated embodiment, the compression limiter 124 may comprise a hollow cylindrical wall defining a fastener opening 134. The fastener opening 134 can be aligned with and generally concentric to the internally threaded bore 128 of the collar 112 along axis 122. The fastener opening 134 can be sized to slidingly receive the shank 108b of the fastener 108. The compression limiter 124 may further be sized and dimensioned to be at least partially received within the second opening 120 of the second component 106, thereby providing radial alignment and positioning of the fastener 108 relative to the nut clip 110 and the components.

The compression limiter 124 and the internally threaded collar 112 may extend in opposite axial directions from a common region of the body portion 138. For example, the compression limiter 124 can extend upwardly relative to the planar portion 138a toward the second component 106, while the internally threaded collar 112 may extend downwardly from the fastener plate 138b away from the second component 106. In certain embodiments, the planar portion 138a and the fastener plate 138b may be arranged substantially parallel to one another and spaced apart by a predetermined distance, which may be selected to contribute to the desired overall stand-off height or distance between the first and second components 104, 106.

During tightening of the fastener 108, compressive load can be transferred from the head 108a and flange 108c of the fastener 108 to the second component 106 and then through the compression limiter 124 to the first component 104. Once the compression limiter 124 is engaged between the first component 104 and the second component 106, further tightening of the fastener 108 may result primarily in load transfer through the compression limiter 124 rather than continued compression of the second component 106. In this manner, the compression limiter 124 can define a maximum compression condition corresponding to its axial height and can limit axial displacement between the first component 104 and the second component 106. This configuration may mitigate crushing of coatings, deformation of lightweight substrates, and damage to sensitive components.

A plurality of dimples 130 may be formed in the fastener plate 138b between the fastener plate 138b and the planar portion 138a. The dimples 130 can act as spacing features configured to help maintain a defined gap between the planar portion 138a and the fastener plate 138b under compressive load. These spacing features may contribute to structural rigidity and load distribution within the nut clip 110 and may assist in maintaining consistent compression-limiting performance.

The fastener 108 can include a head 108a, a shank 108b, and a flange 108c. In the illustrated embodiment, the head 108a may be hexagonal to facilitate engagement by a socket, wrench, or similar tool. The shank 108b may include external threads configured to mate with the internally threaded bore 128 of the collar 112. The flange 108c can increase the contact surface area between the head 108a and the second component 106, distributing clamping load and reducing localized stresses. Although a hex-head bolt is illustrated, other fastener configurations may be used, including alternative head geometries or drive types, provided that the fastener is compatible with the internally threaded collar 112.

During installation, the nut clip 110 can be inserted into the first opening 114 of the first component 104 in the direction indicated by arrow 118. The legs 116 may deflect as necessary to pass through the opening and then engage the perimeter of the opening to retain the nut clip 110 in position. The second component 106 can then be positioned over the first component 104 such that the compression limiter 124 aligns with and may be inserted into the second opening 120. The fastener 108 can be inserted through the second opening 120, through the fastener opening 134 of the compression limiter 124, and into threaded engagement with the internally threaded collar 112. Rotation of the fastener 108 about axis 122 can advance the fastener axially and draw the first and second components 104, 106 together until the compression limiter 124 establishes the predetermined minimum spacing and maximum compression condition.

Optional sealing elements may be provided to mitigate ingress of dust, dirt, water, or other environmental contaminants. For example, a compressible annular seal may be positioned radially about the shank 108b and axially between the second component 106 and the underside of the head 108a to provide a fluid-resistant barrier.

The nut clip 110 may be fabricated from sheet metal using stamping, punching, coining, bending, and extrusion operations. In certain embodiments, the nut clip 110 can be formed from a single sheet of metal that is progressively stamped and bent to create the body portion 138, compression limiter 124, internally threaded collar 112, legs 116, tabs 126, and associated features. The compression limiter 124 and internally threaded collar 112 may be integrally formed from the material of the body portion 138.

The fastener 108 may be fabricated from metal using cold forming, forging, or machining techniques. In alternative embodiments, certain components may be fabricated from polymeric materials using injection molding or additive manufacturing processes, including fused deposition modeling (FDM), stereolithography (SLA), selective laser sintering (SLS), material jetting, binder jetting, powder bed fusion, directed energy deposition, vat photopolymerization, or similar processes.

The first component 104 and the second component 106 may comprise automotive panels, trim components, structural members, pillars, dashboard components, seat frames, center consoles, fenders, sheet metal framework, or other substrates. These components may be fabricated from metals or metal alloys, synthetic or semi-synthetic polymers (including acrylonitrile butadiene styrene (ABS) and polyvinyl chloride (PVC)), composite materials (including fiberglass), or combinations thereof.

In view of the foregoing, the nut clip 110 can provide secure retention within a component opening, controlled compression through the compression limiter 124, a defined axial stand-off, load transfer through a compression-limiting structure, and isolation between adjacent components to mitigate galvanic corrosion. By separating retention and compression-limiting functions and integrating an engineered compression limiter into a nut clip compatible with standard apertures, the nut clip 110 can enhance installation reliability, protect component integrity, and promote consistent performance over repeated installation and service cycles.

While the present method and/or system have been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed:

1. A nut clip comprising:
a body portion configured to engage an opening of a first component;
an internally-threaded collar supported by the body portion and defining an internally-threaded bore configured to receive a threaded fastener along an axis; and
a compression limiter extending from the body portion along the axis,
wherein the compression limiter is configured to engage a second component during tightening of the threaded fastener and define a predetermined maximum compression condition between the first component and the second component.

2. The nut clip of claim 1, wherein the compression limiter comprises a hollow cylindrical wall defining a fastener opening aligned with the internally-threaded bore.

3. The nut clip of claim 2, wherein the hollow cylindrical wall is configured to be at least partially received within an opening of the second component.

4. The nut clip of claim 1, wherein the compression limiter and the internally-threaded collar are generally concentric about the axis.

5. The nut clip of claim 1, wherein the compression limiter extends in a first axial direction and the internally-threaded collar extends in an opposite axial direction.

6. The nut clip of claim 1, wherein the compression limiter is integrally formed from material of the body portion.

7. The nut clip of claim 1, wherein the compression limiter is configured to transfer compressive load between the first component and the second component when the threaded fastener is tightened.

8. The nut clip of claim 1, wherein the compression limiter defines a predetermined axial height corresponding to a maximum allowable compression between the first component and the second component.

9. The nut clip of claim 1, wherein the body portion further comprises resilient retention features configured to engage the opening of the first component in a snap-fit or interference-fit manner.

10. The nut clip of claim 9, wherein the resilient retention features comprise a pair of legs extending from a fastener plate and including at least one attachment feature configured to resist push-through of the nut clip relative to the first component.

11. A nut clip comprising:
a planar portion;
a fastener plate spaced from the planar portion;
an internally-threaded collar extending from the fastener plate and configured to receive a threaded fastener;
wherein the planar portion and the fastener plate are arranged substantially parallel to one another and are spaced apart by a predetermined distance, and
wherein the predetermined distance is configured to provide isolation between a first component and a second component when the nut clip is installed therebetween.

12. The nut clip of claim 11, further comprising at least one spacing feature disposed between the planar portion and the fastener plate and configured to maintain the predetermined distance under compressive load.

13. The nut clip of claim 12, wherein the at least one spacing feature comprises one or more dimples formed in the fastener plate.

14. The nut clip of claim 11, wherein the planar portion includes a compression limiter extending away from the fastener plate.

15. The nut clip of claim 11, wherein the planar portion and the fastener plate are integrally formed from a single piece of sheet metal material.

16. The nut clip of claim 11, wherein the planar portion is configured to engage a second component and the fastener plate is configured to engage a first component such that the predetermined distance reduces direct metal-to-metal contact between the first component and the second component.

17. The nut clip of claim 11, further comprising at least one resilient retention feature extending from the fastener plate and configured to engage an opening of the first component.

18. The nut clip of claim 11, wherein the predetermined distance corresponds to a defined stand-off height that is maintained during tightening of a threaded fastener engaged with the internally-threaded collar.
